(19) United States
(12) Patent Application Publication
(10) Pub. No.: US 2011/0163663 A1
(43) Pub. Date: Jul. 7, 2011

(54) Organic Light Emitting Display Device and Method of Making the Same

(75) Inventor: Rog Hur, Yongin-City (KR)

(73) Assignee: SAMSUNG MOBILE DISPLAY CO., LTD., Yongin-City (KR)

(21) Appl. No.: 12/972,287

(22) Filed: Dec. 17, 2010

(30) Foreign Application Priority Data
Jan. 7, 2010 (KR) 10-2010-0001200

(51) Int. Cl. H01J 1/62; H01J 9/32

(52) U.S. Cl. 313/504; 445/25

(57) ABSTRACT

An organic light emitting display device has improved strength. The organic light emitting display device includes a first substrate and a second substrate sealing the first substrate, wherein the thickness of the first substrate is different from the thickness of the second substrate. A method of making an organic light emitting display device comprises forming elements in a first substrate and sealing the first substrate with a second substrate having a thickness different from a thickness of the first substrate. Finally, an organic light emitting display device comprises a panel and a frame, wherein the panel comprises a first substrate and a second substrate for sealing the first substrate, wherein the thickness of the first substrate is different from the thickness of the second substrate.

### CLAIM OF PRIORITY

This application makes reference to, incorporates the same herein, and claims all benefits accruing under 35 U.S.C. §119 from an application earlier filed in the Korean Intellectual Property Office on 7 Jan. 2010 and there duly assigned Serial No. 10-2010-0001200.

### BACKGROUND OF THE INVENTION

1. Field of the Invention

The present invention relates to an organic light emitting display device and a method of making the same and, more particularly, to an organic light emitting display device having improved strength and a method of making the same.

2. Description of the Related Art

In recent years, various flat panel displays capable of reducing weight and volume, which are deficiencies of a cathode ray tube, have been developed. Examples of the flat panel displays include a liquid crystal display, a field emission display, a plasma display panel, and an organic light emitting display.

Among the flat panel displays, the organic light emitting display displays an image by using an organic light emitting diode (OLED) which generates light by recombination of electrons and holes which are generated in response to the flow of current.

In application fields of the organic light emitting display, the organic light emitting display is used for a personal data assistant (PDA), an MP3 player, etc., in addition to a cellular phone, such that the market for the organic light emitting display is being substantially extended due to its various advantages, such as excellent color reproducibility and thinness.

In the organic light emitting display, a transistor, an organic light emitting diode, a capacitor, etc. and, in addition, wires are formed on a first substrate, and the first substrate is sealed with a second substrate.

At this point, the organic light emitting display can improve its strength by attaching a frame, etc. to the first substrate and the second substrate. However, the improvement in strength is limited.

Furthermore, heat treatment of the first substrate is performed at the time of forming the transistor, the organic light emitting diode, the capacitor and the wires, and as a result, the mechanical strength of the first substrate is deteriorated in comparison to the second substrate.

### SUMMARY OF THE INVENTION

Accordingly, the present invention provides an organic light emitting display having improved strength, and a method of making the same.

According to an aspect of the present invention, an organic light emitting display device includes a first substrate and a second substrate for sealing the first substrate, wherein the thickness of the first substrate is different from the thickness of the second substrate.

Additionally, a resonance frequency of the first substrate and a resonance frequency of the second substrate are set to be different from each other by the difference in thickness between the first substrate and the second substrate.

Furthermore, the thickness of the first substrate is larger than the thickness of the second substrate.

According to another aspect of the present invention, a method of making an organic light emitting display device includes forming elements on a first substrate, and sealing the first substrate with a second substrate having a thickness different from the first substrate.

Additionally, a resonance frequency of the first substrate and a resonance frequency of the second substrate are set to be different from each other by the difference in thickness between the first substrate and the second substrate.

Furthermore, the thickness of the first substrate is larger than the thickness of the second substrate.

In accordance with the present invention, an organic light emitting display device and a method of making the same can improve its strength because thicknesses of a first substrate and a second substrate are set to be different. In particular, it is possible to further reinforce the first substrate, which would otherwise have its strength deteriorated through the heat treatment, etc., by making the thickness of the first substrate larger than the thickness of the second substrate.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is an exploded perspective view showing the structure of an organic light emitting display device according to a first embodiment of the present invention.

FIG. 2 is a cross-sectional view showing a first substrate of the organic light emitting display device shown in FIG. 1.

FIG. 3 is a cross-sectional view showing a first embodiment of a panel of the organic light emitting display device shown in FIG. 1.

FIG. 4 is a cross-sectional view showing an organic light emitting display device according to a second embodiment of the present invention.

FIG. 5 is a diagram showing an impact test result depending on the thickness of a first substrate and the thickness of a second substrate in an organic light emitting display device according to an embodiment of the present invention.

### DETAILED DESCRIPTION OF THE INVENTION

In the following detailed description, only certain exemplary embodiments of the present invention have been shown and described, simply by way of illustration. As those skilled in the art will realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

Embodiments of the present invention will now be described with reference to the accompanying drawings.

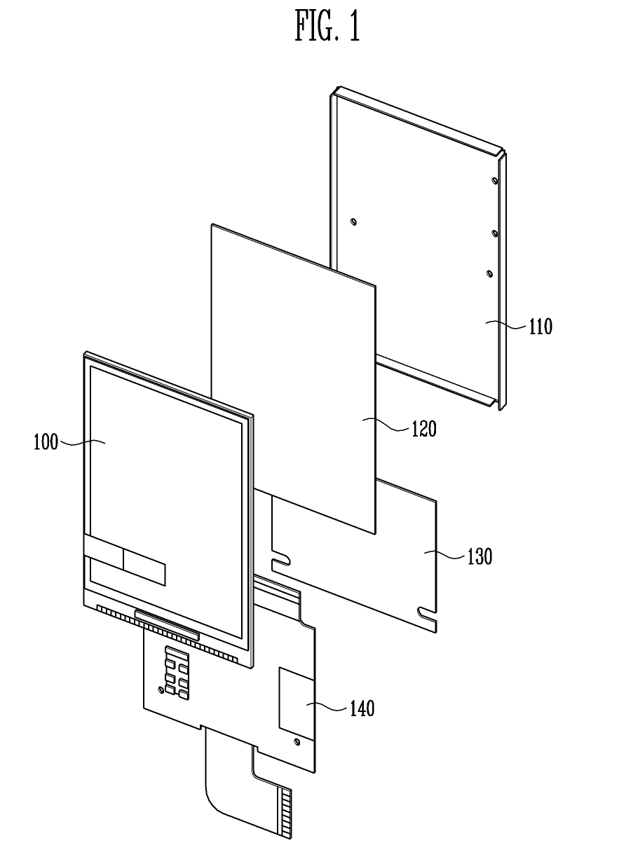

FIG. 1 is an exploded perspective view showing the structure of an organic light emitting display device according to a first embodiment of the present invention. Referring to FIG. 1, the organic light emitting display device includes a panel 100 (constituting a screen), a frame 110, a tape 120, a printed circuit board (PCB) 130, and a PCB tape 140.

The panel 100 includes a first substrate (not shown) and a second substrate (not shown). The first substrate is sealed with the second substrate by a sealant (not shown). In addition, a pixel (not shown) constituted by a transistor, a capacitor, an organic light emitting diode, etc. is formed on the first substrate. The thicknesses of the first substrate and the second substrate are set to be different from each other in order to reinforce the strength of the panel 100.

The frame 110 protects the sides and the rear surface of the panel 100. The strength of the organic light emitting display device is reinforced by the material, the structure, etc. of the frame 110.

The tape 120 is attached to a rear surface of the panel 100 relative to the direction in which light of the panel 100 is radiated. The tape 120 allows the panel 100 to be attached and fixed to the frame 110. Furthermore, damage to the organic light emitting display device by an impact can be reduced by using the tape 120.

The PCB 130 supplies signals and power to the panel 100. A flexible printed circuit board (FPCB) having flexibility may be used for the PCB 130.

The PCB tape 140 connects the PCB 130 to the panel 100, and prevents easy disconnection because the panel 100 and the PCB 130 adhere to each other. Furthermore, the PCB tape 140 can absorb impact, and thus the strength of the organic light emitting display device is reinforced by the PCB tape 140.

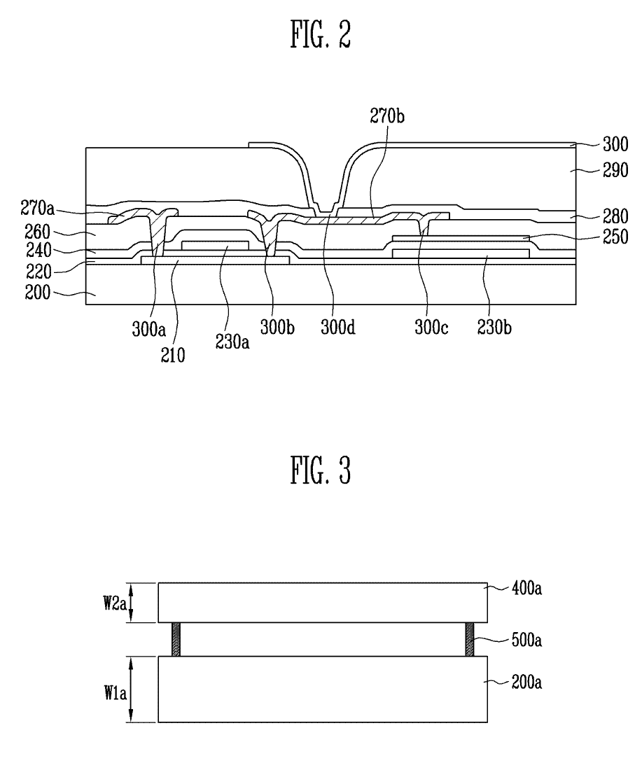

FIG. 2 is a cross-sectional view showing a first substrate of the organic light emitting display device shown in FIG. 1. Referring to FIG. 2, on the substrate 200, an active layer 210 is formed and, thereafter, a first insulating layer 220 is formed. In addition, a first conductive layer is formed and patterned on top of the first insulating layer 220 to form a gate electrode 230a on top of the first insulating layer 220 and above the active layer, and a first electrode 230b of a storage capacitor is formed on the first insulating layer 220 above the substrate 200. At this point, scan lines are formed by the first conductive layer and are connected to the gate electrode 230a. A first electrode 230b of a storage capacitor having a blue pixel among the first electrodes 230b of the storage capacitor is formed at an opening of a white pixel. That is, the gate electrode 230a and the wires are formed on the first conductive layer where the blue pixel is formed and the gate electrode 230a, a first electrode 230b of the storage capacitor of the blue pixel, and a second electrode of a storage capacitor of the white pixel are formed on the first conductive layer where the white pixel is formed. The wires formed in the blue pixel are connected with the storage capacitor of the blue pixel formed in the white pixel.

In addition, after a second insulating layer 240 is formed on top thereof, a second electrode 250 of the storage capacitor is formed at a location opposite to the first electrode 230b of the storage capacitor. Therefore, the second electrode 250 of the storage capacitor of the blue pixel is formed in a white pixel area. In addition, a third insulating layer 260 is formed on top thereof.

In addition, first to third contact holes 300a to 300c are formed, and source-drain metal 270a, 270b is formed. Thus, the source-drain metal 270a, 270b is in electrical contact with the active layer 210 and a second electrode 250 of the storage capacitor through the first to third contact holes 300a to 300c. In addition, a fourth insulating layer 280 is formed on top thereof. At this point, source-drain metal 270a connected to the active layer 210 through the contact hole 300a is formed as a source electrode of a thin-film transistor, and source-drain metal 270b connected to the active layer 210 through the second contact hole 300b is formed as a drain electrode of the thin-film transistor. Furthermore, source-drain metal 270b connected with the second electrode of the storage capacitor through the third contact hole 300c is connected to a drain electrode of the thin-film transistor. As a result, signals transmitted through the transistor are transmitted to the storage capacitor.

In addition, a planarization layer 290 is formed, a fourth contact hole 300d which contacts the source-drain metal 270b is formed, and a pixel electrode 300 is formed. Accordingly, the pixel electrode 300 contacts the source-drain metal 270b through the fourth contact hole 300d so as to receive a signal transmitted through the thin-film transistor.

FIG. 3 is a cross-sectional view showing a first embodiment of a panel of the organic light emitting display device shown in FIG. 1. Referring to FIG. 3, the panel of the organic light emitting display device includes a first substrate 200a and a second substrate 400a.

An organic light emitting diode, a pixel circuit, scan lines, data lines, and power lines are formed on the first substrate 200a. When the organic light emitting diode, pixel circuit, scan lines, data lines, and power lines are formed on the first substrate 200a, an etching process for crystallizing and patterning a silicon layer and a heat treatment process are performed.

The second substrate 400a is positioned so as to face the first substrate 200a. The second substrate 400a seals the first substrate 200a so as to prevent moisture, air, etc. from permeating from the outside. For this purpose, the second substrate 400a is adhered to the first substrate 200a by using a sealant 500a.

At this point, the thickness W1a of the first substrate 200a is larger than the thickness W2a of the second substrate 400a. In addition, the first substrate 200a and the second substrate 400a have a thickness difference so as to set resonance frequencies of the first substrate 200a and the second substrate 400a to be different from each other. Therefore, the first substrate 200a and the second substrate 400a are prevented from being damaged due to a small impact by a resonance.

FIG. 4 is a cross-sectional view showing an organic light emitting display device according to a second embodiment of the present invention.

Referring to FIG. 4, an organic light emitting diode, a pixel circuit, scan lines, data lines, and power lines are formed on a first substrate 200b. When the organic light emitting diode, pixel circuit, scan lines, data lines, and power lines are formed on the first substrate 200b, a silicon layer, an insulating layer, a metallic layer, etc. are vapor-deposited and etched.

A second substrate 400b is positioned so as to face the first substrate 200b. The second substrate 400b seals the first substrate 200b so as to prevent moisture, air, etc. from permeating from the outside. For this purpose, the second substrate 400b is adhered to the first substrate 200b by using a sealant 500b.

At this point, the thickness W2b of the second substrate 400b is larger than the thickness W1b of the first substrate 200b. In addition, the first substrate 200b and the second substrate 400b have a thickness difference so as to set resonance frequencies of the first substrate 200b and the second substrate 400b to be different from each other. Therefore, the first substrate 200b and the second substrate 400b are prevented from being damaged due to a small impact by a resonance.

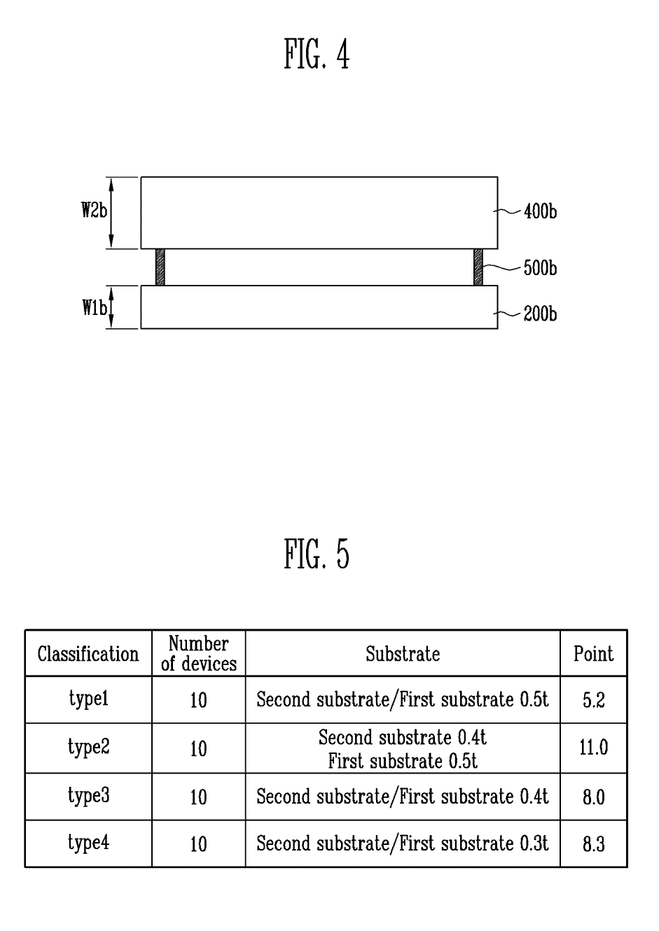

FIG. 5 is a diagram showing an impact test result depending on the thickness of a first substrate and the thickness of a second substrate in an organic light emitting display device according to an embodiment of the present invention.

Referring to FIG. 5, type 1 represents a case in which the thicknesses of the first substrate and the second substrate are the same as each other, and type 2 represents a case in which the thickness of the first substrate is 0.5 t and the thickness of the second substrate is 0.4 t. Type 3 represents a case in which the thicknesses of the first substrate and the second substrate are 0.4 t, and Type 4 represents a case in which the thicknesses of the first substrate and the second substrate are 0.3 t.

At this point, the impact test is performed with respect to 10 organic light emitting display devices for each of type 1 to type 4.

Type 1 acquired a point of 5.2, type 2 acquired a point of 11, type 3 acquired a point of 8, and type 4 acquired a point of 8.3 from the impact test result. That is, according to the impact test result of type 1, type 3, and type 4, as the thicknesses of the first substrate and the second substrate are smaller, a higher point in the impact test is acquired. However, although the thickness of the first substrate of type 2 is 0.5 t and the thickness of the second substrate of type 2 is 0.4 t, type 2 acquired a higher point than the type 1, type 3 and type 4.

From the test results, when the thicknesses of the first substrate and the second substrate are different from each other, particularly, the thickness of the first substrate is the larger, a higher point is acquired. When the transistor, organic light emitting diode, capacitor, etc. are formed on the first substrate, a crystallization process and an etching process are performed. At this point, an additional heat treatment process is performed on the first substrate and, as a result, the first substrate may be lower than the second substrate in strength.

Accordingly, it is possible to improve the strength of the organic light emitting display device by making the thicknesses of the first substrate and the second substrate different from each other, in particular, by making the thickness of the first substrate larger than the thickness of the second substrate.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display device, comprising:
a first substrate; and
a second substrate sealing the first substrate;
wherein the thickness of the first substrate is different from the thickness of the second substrate.

2. The organic light emitting display device of claim 1, wherein a resonance frequency of the first substrate and a resonance frequency of the second substrate are set to be different from each other by the difference in thickness between the first substrate and the second substrate.

3. The organic light emitting display device of claim 1, wherein the thickness of the first substrate is larger than the thickness of the second substrate.

4. The organic light emitting display device of claim 1, wherein the thickness of the first substrate is smaller than the thickness of the second substrate.

5. A method of making an organic light emitting display device, comprising the steps of:
forming elements on a first substrate; and
sealing the first substrate with a second substrate having a thickness different from a thickness of the first substrate.

6. The method of claim 5, wherein a resonance frequency of the first substrate and a resonance frequency of the second substrate are set to be different from each other by the difference in thickness between the first substrate and the second substrate.

7. The method of claim 5, wherein the thickness of the first substrate is larger than the thickness of the second substrate.

8. The method of claim 5, wherein the thickness of the first substrate is smaller than the thickness of the second substrate.

9. An organic light emitting display device, comprising:
a panel; and
a frame for protecting sides and a rear surface of the panel;
wherein the panel comprises a first substrate and a second substrate for sealing the first substrate; and
wherein a thickness of the first substrate is different from a thickness of the second substrate.

10. The organic light emitting display device of claim 9, wherein a resonance frequency of the first substrate and a resonance frequency of the second substrate are set to be different from each other by the difference in thickness between the first substrate and the second substrate.

11. The organic light emitting display device of claim 9, wherein the thickness of the first substrate is larger than the thickness of the second substrate.

12. The organic light emitting display device of claim 9, wherein the thickness of the first substrate is smaller than the thickness of the second substrate.

13. The organic light emitting display device of claim 9, further comprising a tape disposed between the panel and the frame, and attached to the rear surface of the panel for facilitating attachment of the frame to the panel.

14. The organic light emitting display device of claim 13, wherein a resonance frequency of the first substrate and a resonance frequency of the second substrate are set to be different from each other by the difference in thickness between the first substrate and the second substrate.

15. The organic light emitting display device of claim 13, wherein the thickness of the first substrate is larger than the thickness of the second substrate.

16. The organic light emitting display device of claim 13, wherein the thickness of the first substrate is smaller than the thickness of the second substrate.

17. The organic light emitting display device of claim 13, further comprising a printed circuit board (PCB) disposed between the tape and the frame for supplying signals and power to the panel.

18. The organic light emitting display device of claim 17, wherein a resonance frequency of the first substrate and a resonance frequency of the second substrate are set to be different from each other by the difference in thickness between the first substrate and the second substrate.

19. The organic light emitting display device of claim 17, wherein the thickness of the first substrate is larger than the thickness of the second substrate.

20. The organic light emitting display device of claim 17, wherein the thickness of the first substrate is smaller than the thickness of the second substrate.
